(19) United States
(12) Patent Application Publication
(10) Pub. No.: US 2015/0171491 A1
(43) Pub. Date: Jun. 18, 2015

(54) METHOD OF PREVENTING CONDENSATION OF BATTERY PACK

(71) Applicants: Hyundai Motor Company, Seoul (KR); Kia Motors Corporation, Seoul (KR)

(72) Inventor: Do-Kyoung LIM, Suwon-si (KR)

(73) Assignees: KIA MOTORS CORPORATION, Seoul (KR); HYUNDAI MOTOR COMPANY, Seoul (KR)

(21) Appl. No.: 14/321,329

(22) Filed: Jul. 1, 2014

(30) Foreign Application Priority Data
Dec. 18, 2013 (KR) 10-2013-0158470

(51) Int. Cl. H01M 10/615; H01M 10/625; H01M 10/48

(52) U.S. Cl. CPC H01M 10/5006; H01M 10/486; H01M 10/48; H01M 10/5016; H01M 2220/20

(57) ABSTRACT

A method of preventing condensation of a battery pack in an eco-friendly vehicle including measuring a temperature of the battery pack provided in the eco-friendly vehicle and a temperature of air introduced into the battery pack through an air-cooled device for maintaining the battery pack at a set temperature. A humidity of air introduced into the battery pack is measured. Whether condensation is generated is determined based on the temperature of the battery pack, the air temperature, and the air humidity; and the temperature of the battery pack is increased.

### CROSS-REFERENCE(S) TO RELATED APPLICATIONS

This application claims the benefit of priority to Korean Patent Application No. 10-2013-0158470, filed on Dec. 18, 2013, which is incorporated herein by reference in its entirety.

### TECHNICAL FIELD

The present inventive concept relates to a method of preventing condensation of a battery pack, and more particularly, to a method of preventing condensation from being generated on a battery pack, which prevents water droplets by increasing temperature of the battery pack.

### BACKGROUND

An eco-friendly vehicle such as a hybrid vehicle or an electric vehicle is equipped with a motor which does not cause exhaust gas during driving.

The motor generates torque using power, and a high capacity battery pack is provided in the vehicle for continuity of driving.

In general, the battery pack forms a module configured by connecting a plurality of batteries in series in order to provide a target output or is manufactured by connecting a plurality of modules in parallel in order to increase a driving time.

Since the battery pack is configured by accumulation of the plurality of batteries, the battery pack generates heat during charge and discharge thereof causes a decrease in durability of the battery pack. Thus, the battery pack is preferably maintained at a specific temperature.

To achieve this, the eco-friendly vehicle generally has a device capable of maintaining the battery pack at the specific temperature.

In particular, as shown in FIG. 1, an air-cooled device for maintaining a conventional battery pack at a specific temperature introduces vehicle outdoor or indoor air A into a battery pack B.

In a case of the air-cooled device, when a vehicle operates after the battery pack B is cooled to a low temperature as the vehicle is turned off in a cold environment, or the vehicle operates in a case where the temperature of the outdoor air A is increased or in a cold and humid region, condensation may be generated on a surface of the battery pack B due to a difference between the temperature of the vehicle outdoor or indoor air A introduced into the battery pack and the temperature of the battery pack B.

The condensation generated on the battery pack B to thereby causes a reduction in insulation resistance. Therefore, the eco-friendly vehicle has an increased risk of smoke and fire generation, and corrosion is generated on the battery pack B. Consequently, since a short circuit 10 is generated in a voltage sensing terminal as shown in FIG. 2, safety of the vehicle is decreased.

While the battery pack B is formed with a condensation outlet in order to remove the condensation generated on the battery pack B, the decrease in the eco-friendly vehicle safety due to the condensation on the battery pack B may be not sufficiently avoided.

### SUMMARY

An aspect of the present disclosure is directed to a method of preventing condensation of a battery pack, capable of preventing condensation generation by operating a temperature elevation device mounted to the battery pack based on a humidity sensor and a temperature sensor.

Other objects and advantages of the present disclosure can be understood by the following description and become apparent with reference to the exemplary embodiments of the present disclosure.

In accordance with an embodiment of the present invention, a method of preventing condensation of a battery pack in an eco-friendly vehicle includes measuring a temperature of a battery pack provided in the eco-friendly vehicle and a temperature of air introduced into the battery pack through an air-cooled device for maintaining the battery pack at a set temperature. A humidity of air introduced into the battery pack is measured. Whether condensation is generated is determined based on the temperature of the battery pack, the air temperature, and the air humidity, and the temperature of the battery pack is increased.

The step of determining whether condensation is generated may include determining whether the humidity is higher than a set value. A temperature deviation value at which the condensation is capable of being generated is identified when the humidity is more than the set value. Whether a difference between the air temperature and the temperature of the battery pack is less than the deviation value is calculated and determined.

The step of measuring the temperature may be executed when the humidity is less than the set value.

The step of measuring the temperature may be executed when the difference between the air temperature and the temperature of the battery pack is more than the deviation value.

The step of increasing the temperature may include operating a temperature elevation device provided in the battery pack. Whether the temperature of the battery pack is significantly increased compared to a temperature deviation value at which condensation is capable of being generated is determined. The temperature elevation device stops the operation when the temperature of the battery pack is significantly increased compared to the deviation value.

In accordance with another embodiment of the present disclosure, an apparatus for preventing condensation of a battery pack in an eco-friendly vehicle includes the battery pack provided in the eco-friendly vehicle. A temperature sensor is provided within the battery pack. A humidity sensor is provided in an air-cooled device for maintaining the battery pack at a set temperature. An air temperature sensor is provided in the air-cooled device, and a temperature elevation device is provided in the battery pack.

The apparatus may further include a controller which controls the temperature elevation device through a value measured by the temperature sensor, the humidity sensor, and the air temperature sensor.

The controller may store data of a temperature deviation value at which condensation is capable of being generated relative to the value measured by the humidity sensor.

The temperature elevation device may be a heating grille mounted on an outside surface of the battery pack.

An interior heating grille may be mounted within the battery pack parallel with the heating grille.

### BRIEF DESCRIPTION OF THE DRAWINGS

FIG. 1 is a diagram schematically illustrating an air-cooled device for maintaining a conventional battery pack at a specific temperature.

FIG. 2 is a diagram illustrating a voltage sensing terminal damaged due to condensation generation.

FIGS. 3A and 3B are flowcharts illustrating a method of preventing condensation of a battery pack according to an embodiment of the present disclosure.

FIG. 4 is a view schematically illustrating an apparatus for preventing condensation of a battery pack according to an embodiment of the present disclosure.

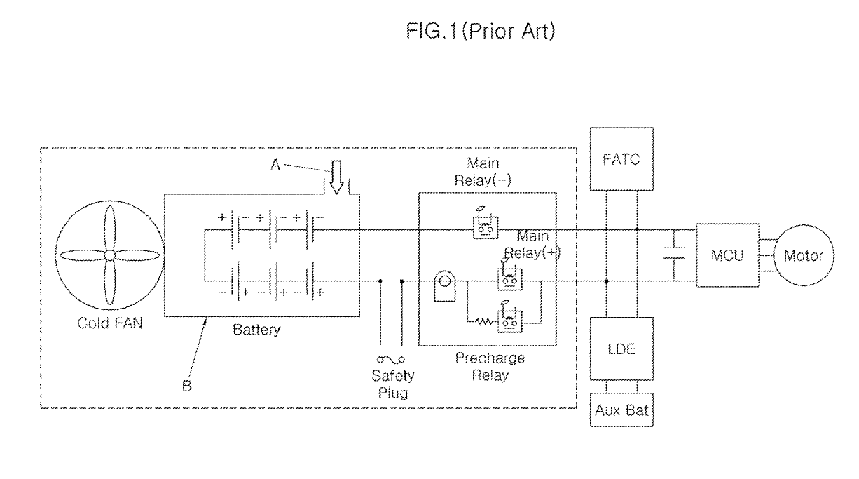

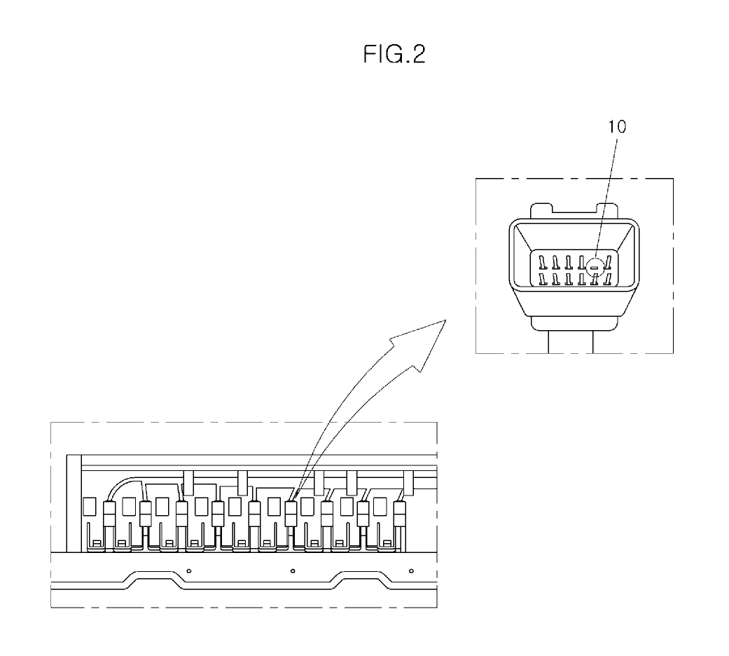

### DESCRIPTION OF EMBODIMENTS

Exemplary embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present inventive concept to those skilled in the art. Throughout the disclosure, like reference numerals refer to like parts throughout the various figures and embodiments of the present invention.

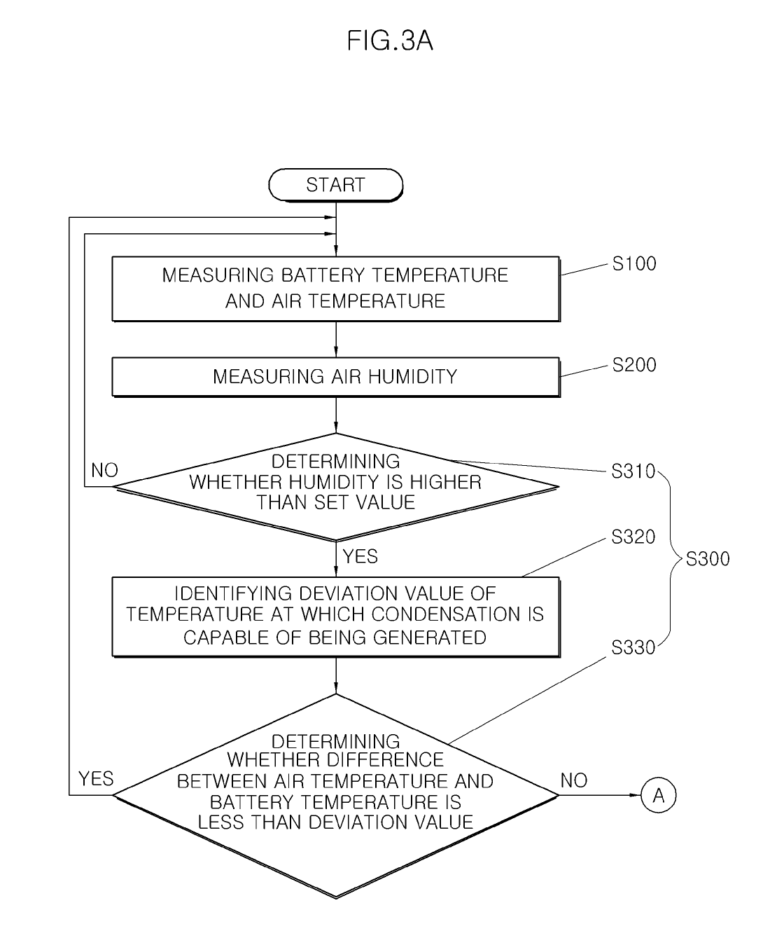

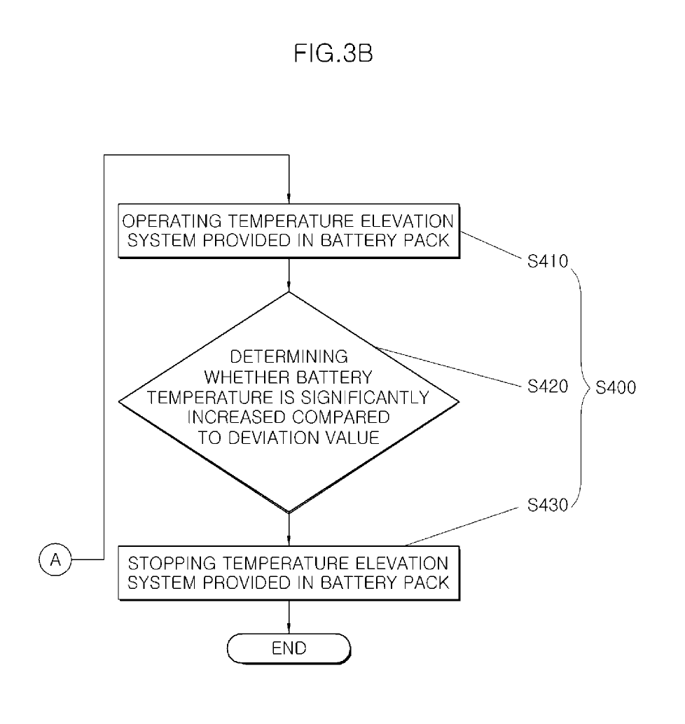

FIGS. 3A and 3B are flowcharts illustrating a method of preventing condensation of a battery pack according to an embodiment of the present disclosure.

As shown in FIGS. 3A and 3B, the method of preventing condensation of the battery pack according to an embodiment of the present disclosure includes a temperature measurement step S100 of measuring a temperature of a battery pack 100 provided in an eco-friendly vehicle and a temperature of air introduced into the battery pack 100 through an air-cooled device for maintaining the battery pack 100 at a set temperature. A humidity measurement step S200 measures humidity of air introduced into the battery pack 100. A condensation generation determination step S300 determines whether condensation is generated based on the temperature of the battery pack 100, the air temperature, and the air humidity. A temperature elevation step S400 increases the temperature of the battery pack 100.

The condensation generation determination step S300 includes a humidity amount determination step S310 of determining whether the humidity is higher than a set value. A temperature deviation identification step S320 identifies a temperature deviation value at which the condensation is capable of being generated when the humidity is more than the set value. A temperature difference calculation step S330 determines whether a difference between the air temperature and the temperature of the battery pack 100 is more than the deviation value.

The humidity amount determination step S310 compares the humidity with a set value which is moisture existing as a gaseous state in the air introduced into the battery pack 100 at a certain temperature, namely the humidity at which water vapor begins to condense. The set value may be set as suitable for a driving environment. In other words, the set value may be set high in a humid region and low in a dry region.

The deviation value identified by the temperature deviation identification step S320 is a temperature decrease value when the air temperature is decreased, and the water vapor begins to condense in a current humidity state of the air introduced into the battery pack 100. The deviation value is measured to be suitable for the driving environment and is prepared as set data.

The temperature difference calculation step S330 determines whether the difference between the air temperature and the temperature of the battery pack 100 is less than the deviation value. The difference between the air temperature and the temperature of the battery pack 100 being not less than the deviation value means that a temperature decrement of air introduced into the battery pack 100 to come into contact with the battery pack 100 is more than the temperature decrease value. When the air comes into contact with the battery pack 100, water vapor contained in the air condenses and begins to be formed on the battery pack 100.

The temperature measurement step S100 is performed when the humidity is less than the set value at the humidity amount determination step S310, and the temperature measurement step S100 is performed when the difference between the air temperature and the temperature of the battery pack 100 is less than the deviation value.

The temperature elevation step S400 includes a temperature elevation device operation step S410 of operating a temperature elevation device 500 provided in the battery pack 100. An anti-condensation temperature reaching determination step S420 determines whether the temperature of the battery pack 100 is significantly increased compared to a temperature deviation value at which condensation is capable of being generated. A temperature elevation device stop step S430 stops the temperature elevation device 500 when the temperature of the battery pack 100 is significantly increased compared to the deviation value.

The anti-condensation temperature reaching determination step S420 determines whether a difference between the temperature of the battery pack 100 and the temperature of air introduced into the battery pack 100 by increase in the temperature of the battery pack 100 according to operation of the temperature elevation device 500 is decreased compared to the temperature deviation value.

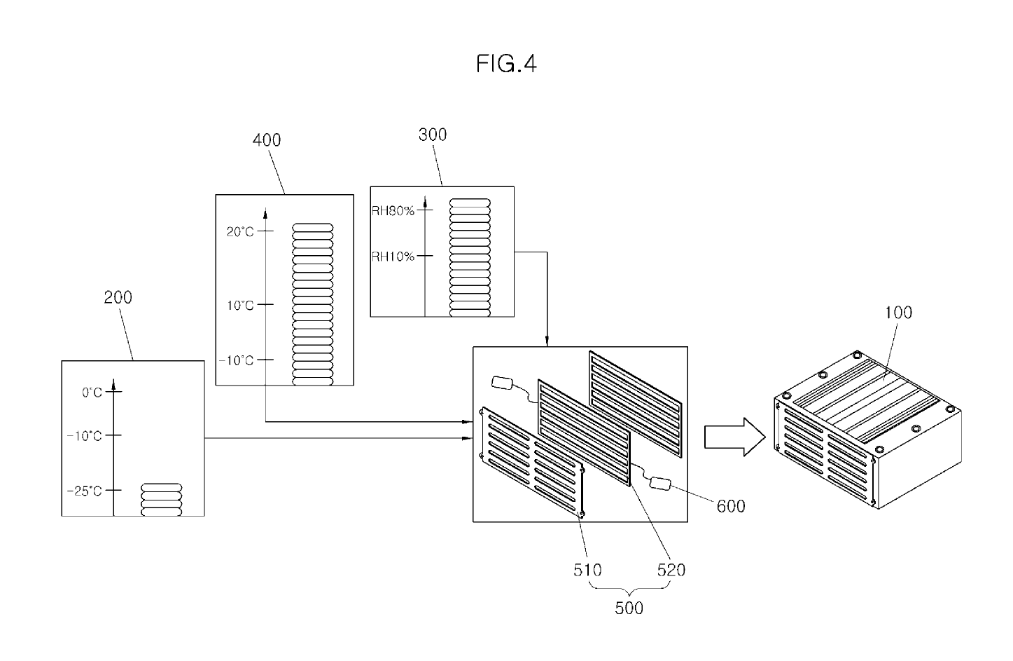

FIG. 4 is a view schematically illustrating an apparatus for preventing condensation of a battery pack according to an embodiment of the present invention.

As shown in FIG. 4, the apparatus for preventing condensation of a battery pack according to an embodiment of the present invention includes a battery pack 100 provided in an eco-friendly vehicle, a temperature sensor 200 provided within the battery pack 100, a humidity sensor 300 provided in an air-cooled device for maintaining the battery pack 100 at a set temperature, an air temperature sensor 400 provided in the air-cooled device, and a temperature elevation device 500 provided in the battery pack 100.

The apparatus further includes a controller 600, which controls the temperature elevation device 500 through a value measured by the temperature sensor 200, the humidity sensor 300, and the air temperature sensor 400.

The controller 600 stores data of a temperature deviation value at which condensation is capable relative to the value measured by the humidity sensor 300.

The temperature elevation device 500 includes a heating grille 510 mounted on an outside surface of the battery pack 100, and an interior heating grille 520 mounted within the battery pack 100 parallel with the heating grille 510.

In accordance with a method of preventing condensation of a battery pack according to an exemplary embodiment of the present disclosure, since a temperature elevation device provided in a battery pack for improving an output at an extremely low temperature is actively operated when condensation may be generated on the battery pack, it may be possible to prevent condensation generation of the battery pack beforehand.

Since the condensation generation is prevented, it may be possible to prevent a reduction of insulation resistance, corrosion of the battery pack, a short circuit of a voltage sensing terminal, and the like, which may deteriorate safety of a vehicle.

It may be possible to enhance durability of a module and a battery within the battery pack and increase a lifespan of an electronic component.

In addition, even when the battery pack has a small space to be mounted, the temperature elevation device may be mounted in the space due to a simple structure thereof.

While the present inventive concept has been described with respect to the specific embodiments, it will be apparent to those skilled in the art that various changes and modifications may be made without departing from the spirit and scope of the invention as defined in the following claims.

What is claimed is:

1. A method of preventing condensation of a battery pack of an eco-friendly vehicle, the method comprising steps of:
measuring a temperature of the battery pack provided in the eco-friendly vehicle and a temperature of air introduced into the battery pack through an air-cooled device for maintaining the battery pack at a set temperature;
measuring a humidity of the air introduced into the battery pack;
determining whether condensation is generated based on the temperature of the battery pack, the air temperature, and the air humidity; and
increasing the temperature of the battery pack.

2. The method of claim 1, wherein the step of determining whether condensation is generated comprises steps of:
determining whether the humidity is higher than a set value;
identifying a temperature deviation value at which condensation is capable of being generated when the humidity is more than the set value; and
calculating whether a difference between the air temperature and the temperature of the battery pack is less than the deviation value.

3. The method of claim 2, wherein the step of measuring the temperature is executed when the humidity is less than the set value.

4. The method of claim 2, wherein the step of measuring the temperature is executed when the difference between the air temperature and the temperature of the battery pack is more than the deviation value.

5. The method of claim 1, wherein the step of increasing the temperature comprises:
operating a temperature elevation device provided in the battery pack;
determining whether the temperature of the battery pack is significantly increased compared to a temperature deviation value at which condensation is capable of being generated; and
stopping the temperature elevation device when the temperature of the battery pack is significantly increased compared to the deviation value.

6. An apparatus for preventing condensation of a battery pack in an eco-friendly vehicle, the apparatus comprising:
the battery pack provided in the eco-friendly vehicle;
a temperature sensor provided within the battery pack;
a humidity sensor provided in an air-cooled device for maintaining the battery pack at a set temperature;
an air temperature sensor provided in the air-cooled device; and
a temperature elevation device provided in the battery pack.

7. The apparatus of claim 6, further comprising a controller which controls the temperature elevation device through a value measured by the temperature sensor, the humidity sensor, and the air temperature sensor.

8. The apparatus of claim 7, wherein the controller stores data of a temperature deviation value at which condensation is capable of being generated relative to the value measured by the humidity sensor.

9. The apparatus of claim 6, wherein the temperature elevation device is a heating grille mounted on an outside surface of the battery pack.

10. The apparatus of claim 9, wherein an interior heating grille is mounted within the battery pack parallel with the heating grille.
